(19) United States
(12) Patent Application Publication
(10) Pub. No.: US 2013/0058517 A1
(43) Pub. Date: Mar. 7, 2013

(54) In-Ear Headphone with Detachable Ear Hook

(71) Applicants: Noel Lee, Las Vegas, NV (US); Jacky Hsiung, San Jose, CA (US)

(72) Inventors: Noel Lee, Las Vegas, NV (US); Jacky Hsiung, San Jose, CA (US)

(73) Assignee: Monster Cable Products, Inc., Brisbane, CA (US)

(21) Appl. No.: 13/597,180

(22) Filed: Aug. 28, 2012

Related U.S. Application Data
(60) Provisional application No. 61/530,394, filed on Sep. 1, 2011.

(51) Int. Cl. H04R 1/10

(52) U.S. Cl. 381/380

(57) ABSTRACT

This invention comprises an attachable in-ear hook to an earphone. The ear hook portion can attach to the earphone in a variety of ways, including through the use of snap features on the ear hooks in collaboration with a protrusion located on the earphone housing. Another attaching means can include where the housing is attached (permanently or not) to the ear hook and the housing is attachable/detachable to the body of the ear-phone. These attaching/detaching means allow for quick and easy installation and removal of the ear hook.

### CROSS REFERENCE TO RELATED APPLICATIONS

This application claims priority to the filing date of a U.S. provisional patent application having Ser. No. 61/530,394, entitled “Earphone with Detachable Ear Hook”, filed on Sep. 1, 2011 of which is incorporated herein by reference in its entirety.

### BACKGROUND OF THE INVENTION

1. Field of the Invention

The present invention is generally related to in-ear headphones or ear-phones and, more particularly to an earphone with a detachable ear hook.

2. Discussion of the Related Art

Earphones that attach to the user's ear, and in particular remain in contact with portions of the ear such as the upper and/or lower concha are known in the art. So too are ear-phones with in-ear hooks to secure the ear-phones in the ear. However, a drawback with these devices is that due to the large differences in the sizes of human ears, a one size fits all device is not available. Furthermore, ill fitting earphones are either uncomfortable or ineffective. Previous efforts to solve this problem have their own disadvantages. What is needed is a way to adjust the size of the relatively inexpensive ear hook element of the in-ear headphone, while still keeping the headphone portion intact.

### BRIEF SUMMARY OF THE INVENTION

The present invention provides a solution to the problems described above, by providing an ear hook that can be attached to (and/or removed from) the earphone. Having an ear-phone with interchangeable hooks provides great flexibility and adaptability by allowing the user to utilize the earphone and choose which ear hook fits best. Further, the choice of which size ear hook to use may depend on the circumstances. For instance, a smaller hook may provide the most long term comfort, but may not remain secure during physical exercise, such as jogging. In the case of exercise, the user may wish to use a larger hook to provide greater stability. Further, multiple ear hooks with differing colors/designs can be provided, which would allow the user to accessorize with these interchangeable parts.

The ear hook portion can attach to the earphone in a variety of ways, including through the use of snap features on the ear hooks in collaboration with a protrusion located on the earphone housing. Another attaching means can include where the housing is attached (permanently or not) to the ear hook, and the housing is attachable/detachable to the body of the ear-phone. These attaching/detaching means allow for quick and easy installation and removal of the ear hook.

### BRIEF DESCRIPTION OF THE DRAWINGS

FIG. 1 is a perspective view of the earphone and the ear hook, shown unattached;

FIG. 2 is a perspective view of the ear hook with a detent mechanism;

FIG. 3 is a rear view of the headphone housing and protrusion;

FIG. 4 illustrates an alternate embodiment, showing the ear hook attached to the back housing, and the earphone body;

FIG. 5 is an embodiment showing the front view of the inside portion of the housing 18;

FIG. 6 shows the rear of the earphone body 24, as well as the indentations 26, and the earphone body aperture 30.

### DETAILED DESCRIPTION OF THE INVENTION

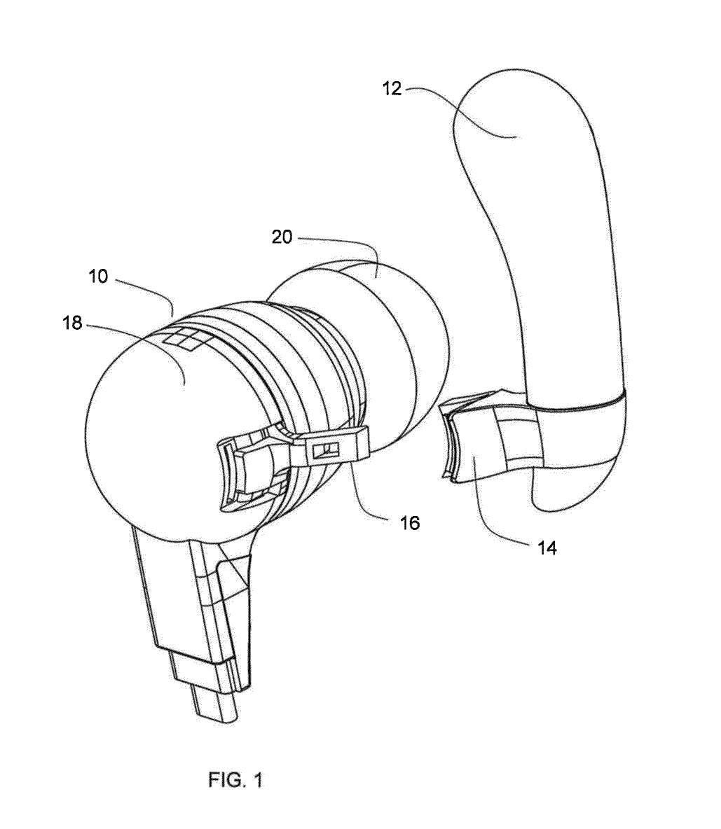

FIG. 1 is a perspective view of the earphone 10 and the ear hook 12 shown unattached. The protrusion 16 extends from the earphone housing 18. The attaching mechanism, comprising the protrusion 16 and the detent mechanism 14 can be located anywhere along the housing 18, however it is preferably located near the back of the housing 16 as shown in FIG. 1. The detent mechanism 14 is attached to the ear hook 12 and, when joined with the protrusion 16, secures the ear hook 12 to the earphone 10.

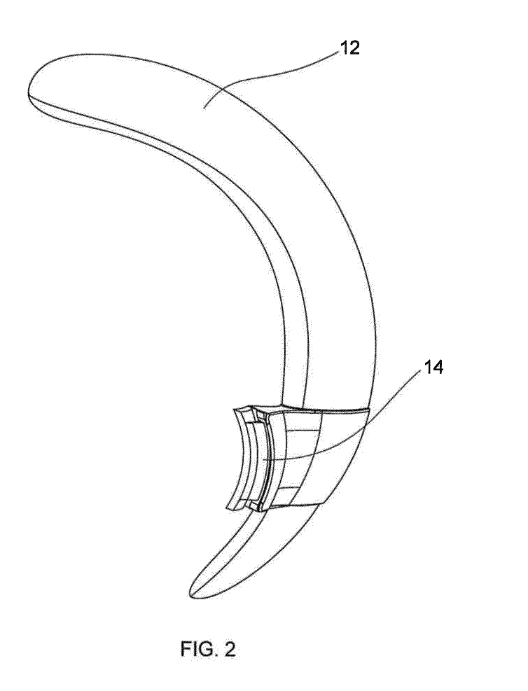

FIG. 2 is a perspective view of the ear hook 12 with a detent mechanism 14. The detent mechanism 14 can press fit or snap into the one or more recesses in the housing 18, The protrusion 16 can assist in securing the detent mechanism and ear hook to the ear-phone.

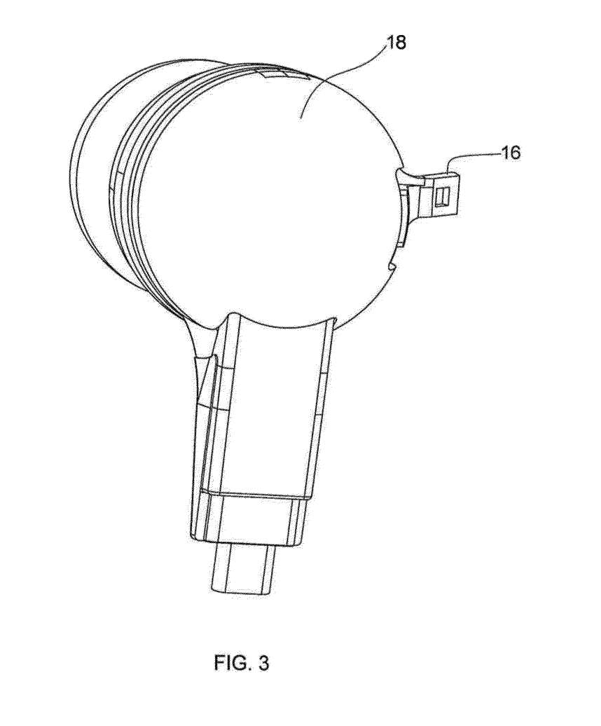

FIG. 3 is a rear view of the headphone housing 18 and protrusion 16. As shown the protrusion 16 can include a hole or cavity to retain and secure a deformable element of the detent.

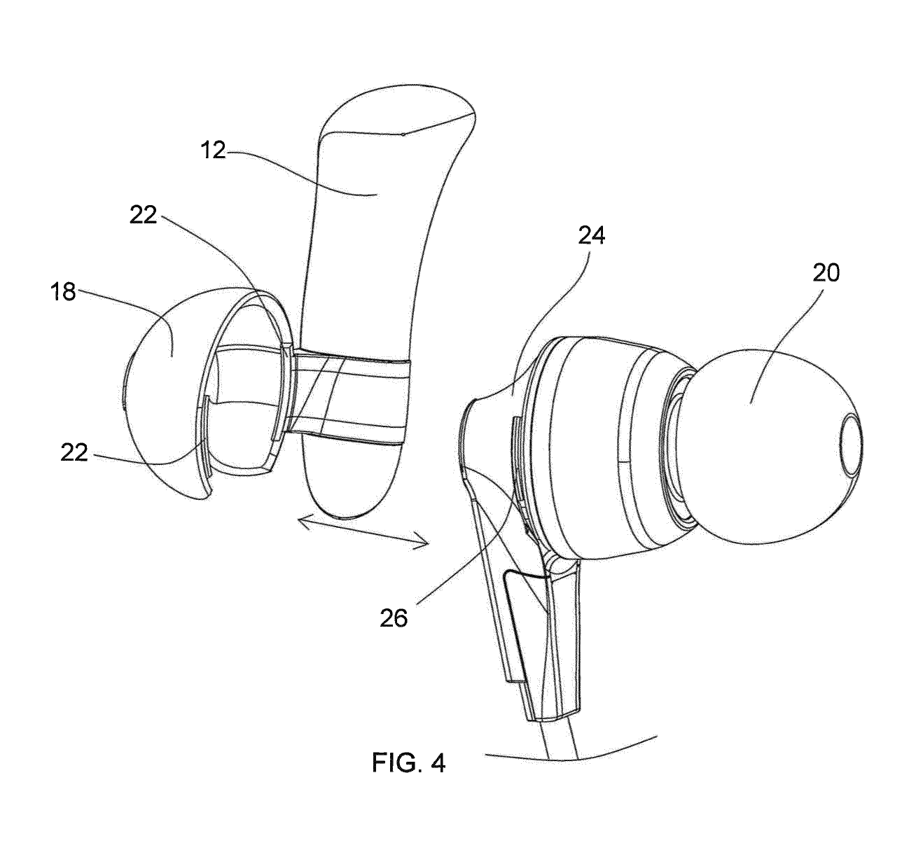

FIG. 4 illustrates an alternative attaching mechanism. Here, the ear hook 12 is attached (permanently or not) to the housing 18. The housing 18 (along with the ear hook 12) can then be attached/detached from the body of the earphone 24. Housing detents 22, shown here as ridges along the inside rim of the housing 18, snap into indentations 26 in the earphone body 24 to secure the housing 18 and the ear hook 12. In this embodiment, the ear hook 12 and housing 18 can be detached by deforming the housing slightly by lifting the housing at one of the housing detents 22, for instance with a fingernail under the housing 18, to remove the housing detent 22 from, the indentation 26. The ear hook 12 is preferably adapted (sized and shaped) to securely fit in a human ear (an in-ear headphone).

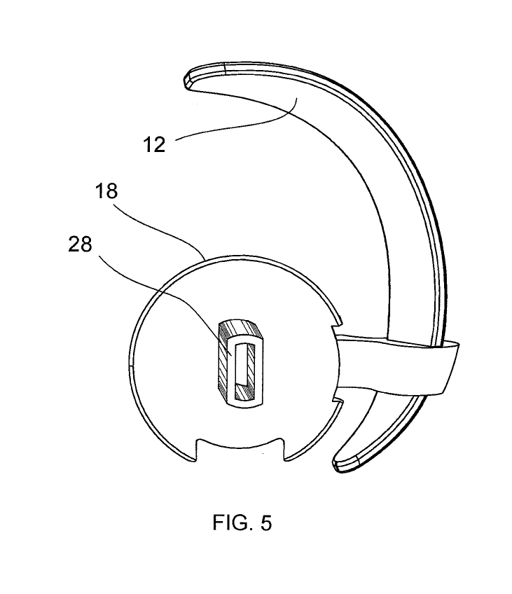

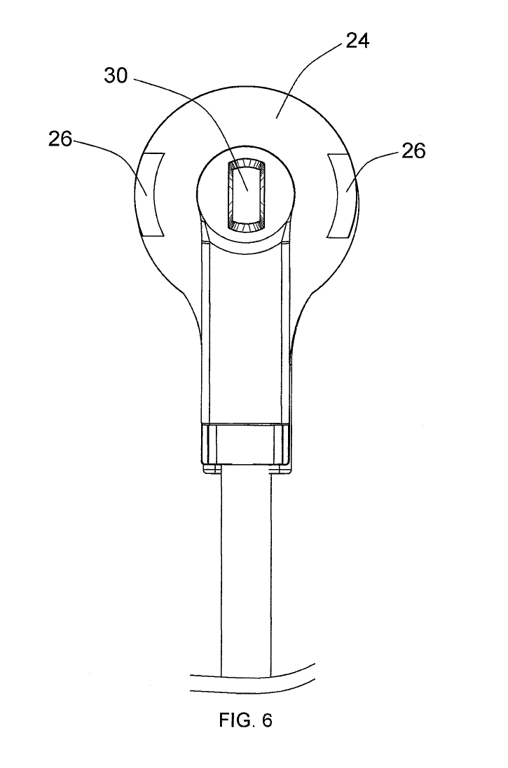

FIG. 5 is a front view of the inside portion of the housing 18. From this view, the housing guide 28 is visible located generally against the middle of the interior surface of the housing 18. The housing guide 28 is configured for insertion into the earphone body aperture 30 (see FIG. 6). The housing guide 28 is preferably sized and shaped similarly to the earphone body aperture 30. However, the housing guide aperture 30 should be slightly smaller dimension so as to allow for penetration into the aperture 30. The purpose of the aperture is to assist in securing/coupling the housing 18 to the earphone body 24.

FIG. 6 shows the rear of the earphone body 24, as well as the indentations 26 and the earphone body aperture 30. As discussed, the housing guide 28 when secured into the earphone body aperture, helps to secure the housing 18 and the ear hook 12. The shape of the housing guide 28 and earphone body aperture 30 (when coupled) assist in keeping the ear hook 12 and housing 18 from rotating or otherwise falling out of proper alignment/position.

We claim:

1. An in-ear headphone (earphone) with an attachable/detachable ear hook, comprising:
a. An earphone, the earphone including:
i. An ear piece; and
ii. An earphone body, wherein the earphone body comprises one or more indentations;
b. An earphone housing, comprising:
i. A generally hollow hemispherical shape;
ii. A rim along an open side of the hemisphere;
iii. Housing detents along the inside edge of the rim, wherein the housing-detents are sized and shaped to fit into the one or more indentations in the earphone body; and
c. An ear hook, sized and shaped to fit securely into a human ear, wherein the ear hook is attached to the earphone housing.

2. An attachable/detachable ear hook, comprising:
a. an ear hook:
i. constructed from a material prone to elastic deformation; and
ii. sized and shaped to fit in a concha of a human ear for securing the ear hook by gently pressing against the concha; and
b. an attachment means for securely attaching the ear hook to an earphone.

3. The ear hook of claim 2 further comprising:
a. an earphone, the earphone comprising:
i. an ear piece;
ii. an earphone body coupled to the ear piece, wherein the body is constructed in such a way to allow the ear hook to be securely attached to the earphone by the attachment means.

4. The ear hook of claim 2 wherein the shape of the ear hook is an arc, the arc being sized and shaped such that when worn, the arc gently presses against the concha for securing the earphone in the ear.

5. The ear hook of claim 2, wherein the attachment means comprises a hemispherically shaped earphone housing attached to the ear hook.

6. A method for securing an earphone in a human ear comprising:
a. attaching an ear hook to the earphone, wherein the ear hook is:
i. constructed from a material prone to elastic deformation; and
ii. sized and shaped to fit in a concha of a human ear for securing the ear hook by gently pressing against the walls of the concha; and
b. inserting the earphone with the attached ear hook into the ear such that the ear piece rests in an ear canal or an external auditory meatus of the ear, and the appendage member gently presses against the walls of the concha.

7. The method of claim 6 wherein the shape of the ear hook is an arc sized and shaped such that when worn, the arc gently presses against the concha for securing the earphone in the ear.
